(19) United States
(12) Patent Application Publication
(10) Pub. No.: US 2023/0371442 A1
(43) Pub. Date: Nov. 23, 2023

(54) VERTICAL FARMING APPARATUS, SYSTEMS, AND METHODS

(71) Applicant: V-MAXX, LLC, King George, VA (US)

(72) Inventor: Marcel VYVERBERG, Spotsylvania, VA (US)

(21) Appl. No.: 18/320,518

(22) Filed: May 19, 2023

Related U.S. Application Data
(60) Provisional application No. 63/343,716, filed on May 19, 2022.

(51) Int. Cl. A01G 9/02; A01G 9/14; A01G 9/24

(52) U.S. Cl. CPC A01G 9/022; A01G 9/14; A01G 9/241; A01G 9/247; A01G 9/249

(57) ABSTRACT

A vertical farming system promoting uniform crop airflow in an enclosure may include a crop suspension system including crop containers, suspension extensions connected to the crop containers, and an upper support disposed at an upper side of the enclosure and connected to the suspension extensions. The system may further include a ventilation system including a main upper airway disposed at the upper side of the enclosure, upper branch airways in fluid communication with the main upper airway and disposed at the upper side of the enclosure, a main lower airway disposed at a lower side of the enclosure, and lower branch airways in fluid communication with the main lower airway. The suspension extensions may include subgroups of different lengths relative to the upper support.

### CROSS-REFERENCE TO RELATED APPLICATION(S)

This application claims priority to U.S. Provisional Patent Application 63/343,716, filed in the U.S. Patent and Trademark Office on May 19, 2022, the entire contents of which are herein incorporated by reference.

### BACKGROUND

### 1. Technical Field

Embodiments relate to vertical farming apparatus, systems, and methods promoting improved airflow, temperature control, humidity control, light distribution, and water and nutrient distribution, leading to improved crop uniformity and crop yield.

### 2. Discussion of the Related Art

Vertical farming is used with some farming operations. Rather than a single layer such as may be associated with the traditional concept of farming (e.g., on the ground), vertical farming involves growing crops using multiple stacked layers provided by infrastructure beyond a simple field and/or a greenhouse. Such infrastructure for vertical farming often includes tables, carts, shelves, or other supports to form each level, as well as additional elements for supporting lights and moving air. By doubling, tripling, or otherwise multiplying the available space for a crop, crop yield may be increased.

While vertical farming can be advantageous in terms of available space for a crop, vertical farming is not without its challenges. For example, one challenge is to economically and effectively provide adequate light to each region of a crop (e.g., light distribution). This may be a challenge level to level, and also within each level, and is caused at least in part by the infrastructure used in vertical farming. Another serious challenge is to economically and effectively control airflow, also due at least in part to vertical farming infrastructure. Related thereto are the challenges of economically and effectively controlling temperature and humidity for each region of a crop, and providing for water and nutrient distribution. For example, energy costs for controlling lighting, airflow, temperature, and humidity may be significant using, for example, many lights and air tubes routed throughout a vertical farm greenhouse including on multiple levels. As another example, devices and/or labor for providing water and nutrient distribution to such crops may also be significant.

Even after incurring such costs in an attempt to gain some crop atmosphere control and adequate water and nutrient distribution, the resulting lighting, air flow, temperature, humidity, and water and nutrient distribution may be less than optimal due to infrastructure impeding airflow control (which directly affects temperature and humidity), lighting control, and water and nutrient distribution. Stated differently, infrastructure for vertical farming may provide an inherent impediment to uniform lighting and airflow control, and also to water and nutrient distribution.

Lack of uniformity in any of lighting, airflow control, temperature control, humidity control, and water and nutrient distribution for a crop can cause multiple problems, including, e.g., a lack of uniformity in a resulting final product, and a lower level of quality of the final product.

This background section is intended to provide context and may contain recognitions not part of the knowledge of those of ordinary skill in the art as of the effective filing date of this disclosure and is not admitted prior art.

### SUMMARY

Aspects of the present disclosure provide vertical farming apparatus, systems, and methods, which promote uniform airflow (e.g., vertical airflow) throughout a crop, e.g., of a greenhouse, an enclosed box, or other types of enclosures. Accordingly, improved airflow control, improved temperature control, and improved humidity control may be achievable for substantially an entire crop, as may be improved water and nutrient distribution. Crop disinfection preventing air born viruses and/or pests may be achievable, as may correct Vapor Pressure Deficit (VFD) optimized air. These improved aspects lead to higher energy efficiency and greater crop yield and quality in terms of commercial applications.

According to an embodiment, a vertical farming system promoting uniform crop airflow in an enclosure may be provided. The system may include a crop suspension system including crop containers, suspension extensions connected to the crop containers, and an upper support disposed at an upper side of the enclosure and connected to the suspension extensions. The system may further include a ventilation system including a main upper airway disposed at the upper side of the enclosure, upper branch airways in fluid communication with the main upper airway and disposed at the upper side of the enclosure, a main lower airway disposed at a lower side of the enclosure, and lower branch airways in fluid communication with the main lower airway. The suspension extensions may include subgroups of different lengths relative to the upper support.

The enclosure may be a greenhouse.

The system may further include a first subgroup of the crop containers that are connected to the user support by a first subgroup of the suspension extensions having a first length, the first subgroup of crop containers being suspended at a first distance relative to the upper support. The system may further include a second subgroup of the crop containers that are connected to the user support by a second subgroup of the suspension extensions having a second length, the second subgroup of crop containers being suspended at a second distance relative to the upper support, the second distance being greater than the first distance. The system may further include a third subgroup of the crop containers that are connected to the user support by a third subgroup of the suspension extensions having a third length, the third subgroup of crop containers being suspended at a third distance relative to the upper support, the third distance being greater than the second distance.

The crop suspension system may include links connecting the crop containers to the suspension extensions.

The crop suspension system may include lights.

The ventilation system may include a heater, an air conditioner, a blower, and an airway system, which define a reversable airflow path.

The fan may be in fluid communication with an external environment.

According to an embodiment, a method of installing a vertical farming system promoting uniform crop airflow in an enclosure may be provided. The method may include installing a crop suspension system in the enclosure by suspending crop containers using suspension extensions that are connected to the crop containers and an upper support disposed at an upper side of the enclosure, and installing a ventilation system in the enclosure by disposing a main upper airway at the upper side of the enclosure, disposing upper branch airways in fluid communication with the main upper airway at the upper side of the enclosure, disposing a main lower airway at a lower side of the enclosure, and disposing lower branch airways in fluid communication with the main lower airway at the lower side of the enclosure. The suspension extensions may include subgroups of different lengths relative to the upper support.

The enclosure may be a greenhouse.

The installing of the crop suspension system may include suspending a first subgroup of the crop containers connected to the user support by a first subgroup of the suspension extensions having a first length at a first distance relative to the upper support. The installing of the crop suspension system may further include suspending a second subgroup of the crop containers connected to the user support by a second subgroup of the suspension extensions having a second length at a second distance relative to the upper support, the second distance being greater than the first distance. The installing of the crop suspension system may further include suspending a third subgroup of the crop containers connected to the user support by a third subgroup of the suspension extensions having a third length at a third distance relative to the upper support, the third distance being greater than the second distance.

The crop suspension system may include links connecting the crop containers to the suspension extensions.

The crop suspension system may include lights.

The ventilation system may include a heater, an air conditioner, a blower, and an airway system, which define a reversable airflow path.

The fan may be in fluid communication with an external environment.

### BRIEF DESCRIPTION OF THE DRAWINGS

The above and other features of the disclosure will become more apparent by describing in detail embodiments thereof with reference to the attached drawings, in which:

FIG. 1 is a front perspective view schematically showing a vertical farming system according to an embodiment.

FIG. 2 is a front perspective view schematically showing a portion of a heating, ventilation, and air conditioning system according to an embodiment.

FIG. 3. is a front perspective view schematically showing a crop container according to an embodiment.

FIG. 4 is a block diagram schematically showing select components of the vertical farming system of FIG. 1.

FIG. 5 is a block diagram schematically showing select components of a vertical farming system according to an embodiment.

FIG. 6 is a front perspective view schematically showing select components of the vertical farming system of FIG. 5.

FIG. 7 is a schematic flow chart showing a method of a method of installing a vertical farming system according to an embodiment.

### DETAILED DESCRIPTION OF THE EMBODIMENTS

In the following description, for purposes of explanation (NOT limitation), specific details are set forth in order to provide an understanding of the described embodiments. It will be apparent to one skilled in the art that other embodiments may be practiced apart from the specific details disclosed below. In other instances, detailed descriptions of well-known methods, devices, techniques, etc. are omitted so as not to obscure the description with unnecessary detail.

As used herein, the singular forms, “a,” “an,” and “the” are intended to include the plural forms as well, unless the context clearly indicates otherwise.

The terms “comprises,” “comprising,” “includes,”, “including,”, “has,” “have,” and/or “having,” and variations thereof, when used herein, specify the presence of stated features, but do not preclude the presence or addition of one or more other features.

“About”, “approximately”, “substantially”, and the like, as used herein is inclusive of the stated value and means within an acceptable range of deviation for the particular value as determined by one of ordinary skill in the art, considering the measurement in question and the error associated with measurement of the particular quantity (e.g., the limitations of a measurement system). For example, “about” may mean within one or more standard deviations, or within ±25%, 15%, 10%, 5%, or 1% of the stated value.

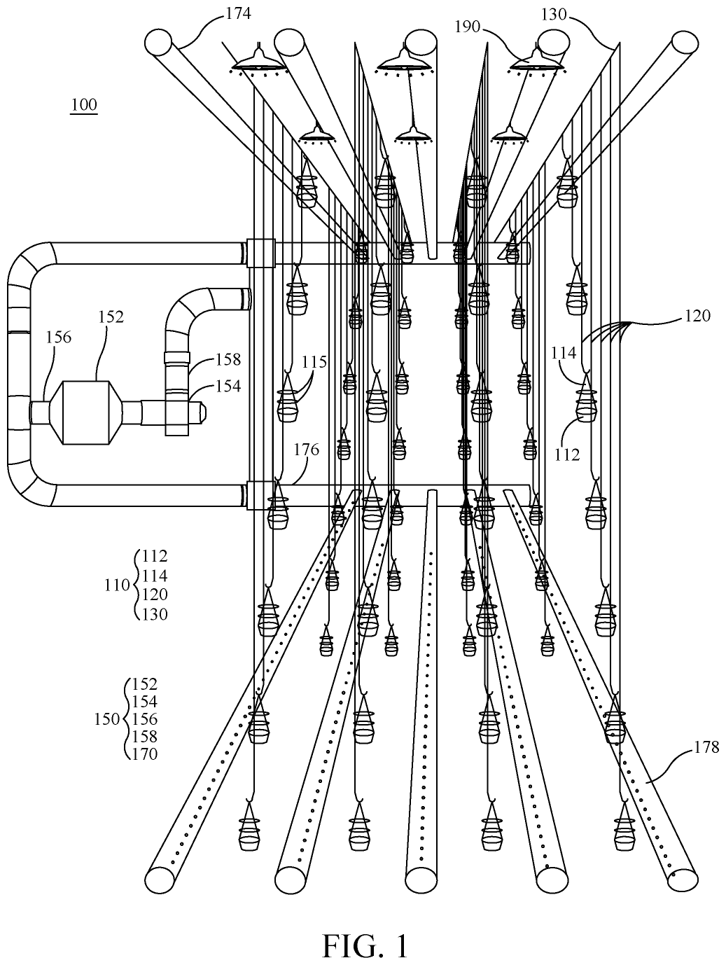

Features described herein as plural features may be combined into a single feature, and features described as a single feature may be separated into multiple features. For example, the container links 114 and suspension extensions 120 described in FIG. 1 are shown as separate features but may be combined in other embodiments into an integral suspension extension including links.

“And/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

Spatially relative terms such as “upper” and “lower” may be used herein for ease of description to describe the relations between one feature and another feature. It will be understood that the spatially relative terms are intended to encompass different orientations of the device in use or operation, in addition to the orientation depicted in the drawings.

As noted in the Discussion of the Related Art section above, vertical farming, while advantageous in terms of available space for a crop, presents its own unique problems in terms of light distribution, airflow, temperature control, humidity control, and water and nutrient distribution. These problems may be due, at least in part, to the very structures necessary for vertical farming.

More specifically, air plays a crucial part in the growth of certain crops due to the fact crops essentially “breathe” and absorb nutrients from surrounding air. The ability of a particular plant to “breathe” (e.g., absorb carbon dioxide) may be affected by airflow around the plant. According to embodiments of the present disclosure, multiple stacked layers (e.g., tiers, levels) of a crop may be suspended such that airflow (e.g., vertical airflow) is not obstructed and lighting efficiency may be improved. Accordingly, improved airflow control, improved temperature control, and improved humidity control may be achievable for substantially an entire crop, as may be improved water and nutrient distribution, as well as disinfection, removal of pests, and correct Vapor Pressure Deficit (VFD) optimized air. Further, the present embodiments may effectively harness heating and cooling principles beyond increased airflow effectiveness to yield even higher energy efficiency and produce crops approaching, meeting, or exceeding pharmaceutical grade quality.

FIG. 1 is a front perspective view schematically showing a vertical farming system 100 according to an embodiment. The vertical farming system 100 may be part of or located within a greenhouse, closed container, enclosed module or other enclosure, and may include a crop suspension system 110 and a heating, ventilation, and air conditioning system 150.

The crop suspension system 110 may enable positioning of crops into multiple levels (or tiers) with minimal or virtually no obstruction to vertical airflow between the levels. The crop suspension system 110 may include crop containers 112, container links 114, suspension extensions 120, and an upper support 130. As with many other concepts described herein, it will be recognized by one of ordinary skill in the art that the embodiment shown in FIG. 1 is but only a schematic example. Other configurations are possible and should be considered to be within the scope of the disclosure.

A height that a particular crop container 112 may be positioned relative to an upper support 130 (or upper plane of the vertical farming system), or a floor (or bottom plane of the vertical farming system 100) may be determined based on a length of a suspension extension 120. For example, a crop container 112 suspended by a suspension extension 120 of a first length may be positioned at a first highest level (e.g., first highest tier), a crop container 112 suspended by a suspension extension 120 of a second length may be positioned at a second highest level (e.g., a second highest tier), a crop container 112 suspended by a suspension extension 120 of a third length may be positioned at a third highest level (e.g., third highest tier), and so on for as many levels or tiers as may be desired.

The crop suspension system 110 may further include additional infrastructure components. For example, the crop suspension system 150 may include lights 190 as shown in FIG. 1. In another embodiment, lights may be suspended substantially similarly to crop containers 112. For example, lights may be suspended by suspension extensions, as described herein. In an embodiment, an upper end of suspension extensions for lights may be connected to a different portion of the upper support 130, or even a support separate from the upper support 130. In an embodiment, different length suspension extensions (e.g., a first subgroup of suspension extensions, a second subgroup of suspension extensions, and a third subgroup of suspension extensions) may be used in suspending lights. In other embodiments, same length suspension extensions may be used to support lights.

Further description regarding the crop suspension system 110 is provided later herein.

The heating, ventilation, and air conditioning system 150 may control air flow, air heating, air cooling, and humidity. The heating, ventilation, and air conditioning system 150 may include a blower 152 including one or more fans, a heater 154, an air conditioner 156, a humidifier/dehumidifier 158, and an airway system 170. The heating, ventilation, and air conditioning system 150 may allow for effective circulation of air throughout a crop, and may be reversable depending upon whether heating or cooling air, e.g., in a greenhouse. It will be recognized that the embodiment shown in FIG. 1 is but only a schematic example. Other configurations are possible and should be considered to be within the scope of the disclosure.

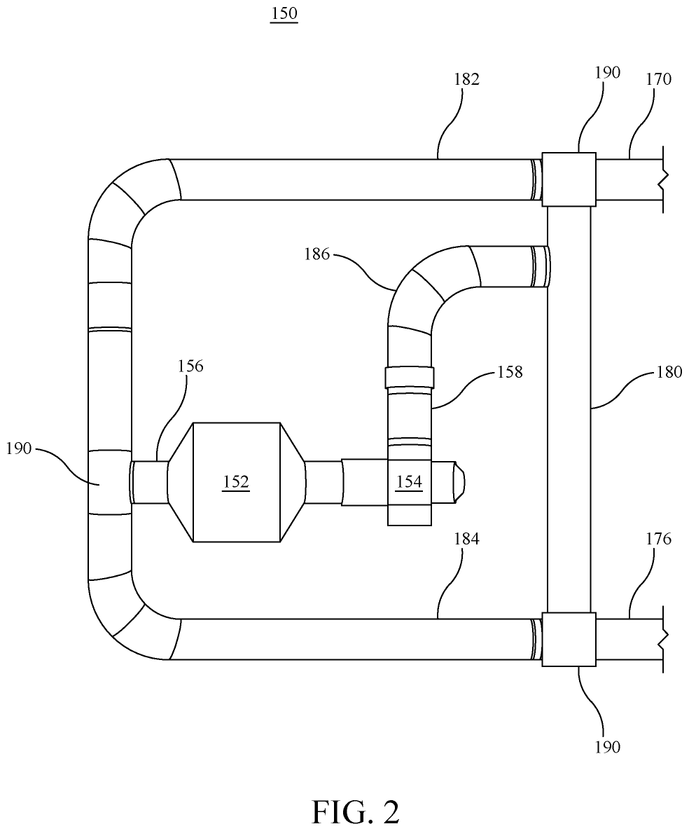

FIG. 2 is a front perspective view schematically showing a portion of a heating, ventilation, and air conditioning system 150 according to an embodiment. Airflow (and thereby temperature and humidity) may be efficiently and effectively controlled using the heating, ventilation, and air conditioning system 150.

According to an embodiment or example, the blower 152, the heater 154, the air conditioner 156, and the humidifier/dehumidifier 158 may be in fluid communication with the airway system 170. The blower 152 may also be in fluid communication with an environment exterior to, e.g., the greenhouse in which the vertical farming system 100 may be housed, thereby allowing for purge cycles of fresh air in the greenhouse. The airway system 170 may include an upper main airway 172 and a lower main airway 176, both located adjacent to a crop (e.g., in the greenhouse) and connected to branch airways (see, e.g., FIG. 1, upper branch airways 174 and lower branch airways 178). The airway system 170 may further include intersystem airways (e.g., 180, 182, 184, 186), dampers such as iris dampers, and airflow valves 190. By means of the intersystem airways 180, 182, 184, 186, and the airflow valves 190, the heating, ventilation, and air conditioning system 150 may be reversable depending upon whether cool air or warm air is desired.

The heating, ventilation, and air conditioning system 150 may include a main upper airway 172 in fluid communication with upper branch airways 174, and a main lower airway 176 in communication with lower branch airways 178. In an embodiment, the upper branch airways 174 may be disposed in the vertical farming system (e.g., the greenhouse) 100 above all levels of crop containers 112. The lower branch airways 178 may be disposed below all levels of the crop containers 112. The upper branch airways 174 and the lower branch airways 178 may be in fluid communication with one or more of the blower 152, the heater 154, the air conditioner 156, the humidifier/dehumidifier 158, and the intersystem airways, 180, 182, 184, 186 via the upper main airway 172 and the lower main airway 176, respectively.

The upper branch airways 174 and the lower branch airways 178 may each include openings through which air may pass. The upper main airway 172, the upper branch airways 174, the lower main airway 176, and/or the lower branch airways 178 may include the iris dampers in order to adjust airflow throughout the heating, ventilation, and air conditioning system 150.

In operation, when cool air is needed to cool the air surrounding the crop containers 112 of the vertical farming system 100, the airflow valves 190 in fluid communication with the intersystem airways 180 may be configured so as to direct cool air from the air conditioner 156 through upper main airway 172 to upper branch airways 174 and out of the openings thereof over the top of the crop containers 112. Due to the unimpeded ability of air to flow vertically in the vertical farming system 100 of the embodiments, cool air may fall from the upper branch airway 174 openings over the crop containers (and their plants) thereby effectively cooling the entire crop and be recirculated by returning back into the heating, ventilation, and air conditioning system 150 through holes of the lower branch airways 178. For example, the configuration of the airflow valves 190 in fluid communication with the intersystem airways 180 may not only act to “push” cool air out of the holes of the upper branch airways 174, but may also create suction (air return) so as to “pull” air into the holes of the lower branch airways 174 for recirculation through the air conditioner 156. In operation, if humidity should be adjusted, the humidifier/dehumidifier 158 may be activated accordingly thereby adding humidity or removing humidity from the cool air from the air conditioner 156 passing through the humidifier/dehumidifier 158. Similarly, if a purge cycle of fresh air is desirable, blower 152 may allow fresh air into the system using, for example, one or more appropriate air valves, the fresh air then being recirculated and cooled.

When warm air is needed to warm the environment surrounding all of the crop containers 112, the airflow valves 190 in fluid communication with the intersystem airways 180 are configured so as to direct warm air from the heater 154 through the lower main airway 176 to the lower branch airways 178 and out of the openings thereof under the crop containers 112. Warmer air will naturally rise so warm air from the openings of the lower branch airways 178 will rise past the crop containers (and their plants) thereby effectively warming the entire crop and being recirculated back into the heating, ventilation, and air conditioning system 150 through holes of the upper branch airways 174. In operation, if humidity should be adjusted, the humidifier/dehumidifier 158 may be activated accordingly thereby adding humidity or removing humidity from the warm air from the heater 154 passing through the humidifier/dehumidifier 158. Similarly, if a purge cycle of fresh air is desirable, blower 152 may allow fresh air into the system using, for example, one or more appropriate air valves and then being recirculated and heated. Through temperature, through other air purification techniques, and through other techniques disclosed herein (e.g., humidity control), improved pest control and crop disinfection may be achieved. Additionally, the present air handling techniques may lead to exactly correct Vapor Pressure Deficit (VFD) optimized air.

Not only is the air direction (and pressure) of the entire heating, ventilation, and air conditioning system 150 controllable, so are regions of the system. For example, if airflow out of one of the upper branch airways 174 or lower branch airways 178 is at rate greater or lower than desirable, then one or more iris dampers located in or near said upper branch airway 174 lower branch airway 178 may be opened or closed, as needed.

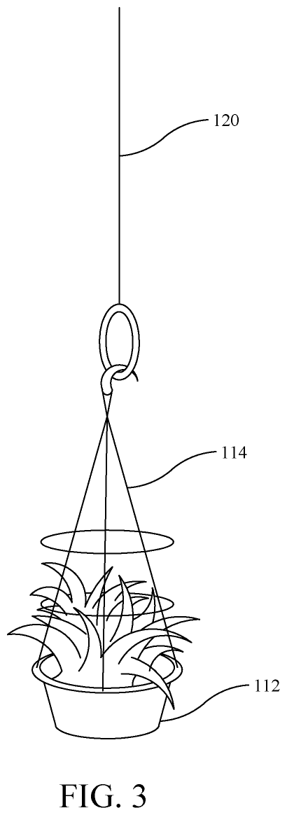

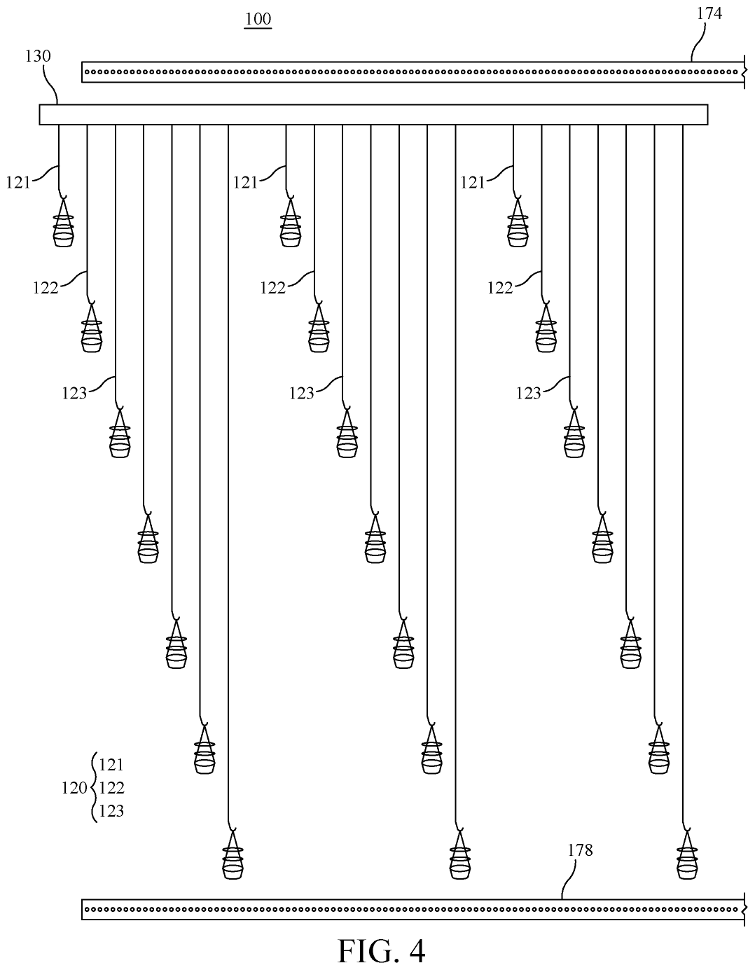

FIG. 3 is a front perspective view schematically showing a crop container 112 according to an embodiment. FIG. 4 is a block diagram schematically showing select components of the vertical farming system 100 of FIG. 1. A crop container 112 may be connected to a suspension extension 120 via container links 114. For example, a lower end of the suspension extension 120 may include a fastener connected to upper ends of the container links. Herein, the term “fastener” is intended to include removable and permanent connectors, such as hooks, holes, bolts, buckles, clamps, clasps, clips, latches, links, nuts, pins, rings, bands, anchors, ties, welds, integral connections, or the like, or combinations thereof. The fastener may be formed of at least one of a polymer, a plastic, a fiber-based material, a metal, a resin, or the like.

As an example of the lower end of the suspension extension 120 including a fastener connected to upper ends of the container's links 114, the lower end of the suspension extension 120 may include a hook which may be engaged with a hook connected to/of upper ends of the container links 114. However, embodiments are not limited thereto. For example, the lower end of the suspension extension 120 may include a hole (e.g., a loop) which may be engaged with hooks of upper ends of the container links 114. In another embodiment, the lower end of the suspension extension 120 may include a hook which may be engaged with holes of upper ends of the container links 114. In another embodiment, the suspension extension 120 and the container links 114 may be integral with each other.

A crop container 112 may include a container body defined by at least one sidewall. The crop container may include a bottom wall adjacent to the sidewall. The bottom wall may be contiguous to the sidewall. An opening may be defined by a side of the sidewall leading to a chamber formed by the sidewall and the bottom wall. For example, a collar may be adjacent to (e.g., integral with) the sidewall and may define the opening. One or more openings may be defined elsewhere in the body of the crop container 112 for drainage. In another embodiment, no openings may be defined in the body of the crop container 112.

In an embodiment, the crop container 112 may have a single sidewall defining a circular shape when viewed from above or below. The circular-shaped sidewall may be straight or may be tapered. However, the shape of the crop container 112 is not limited. For example, a crop container may have three sidewalls defining a triangular shape when viewed from above or below, four sidewalls defining a quadrilateral (e.g., square, rectangle, rhombus or the like), or any number of sides forming another shape (e.g., a pentagon, a hexagon, an octagon, etc.). Further, the bottom wall may be flat or curved or otherwise shaped. In an embodiment, a crop container 112 may range in size from about 2 inches wide, about 2 inches deep, and about 2 inches tall to about 2 feet wide, about 2 feet deep, and about 2 feet tall. In another embodiment, a crop container 112 may range in size from about 2 inches wide, about 2 inches deep, and about 2 inches tall to about 1 foot wide, about 1 foot deep, and about 1 foot tall (e.g., a five gallon pot, a three gallon pot, an 8 inch wide pot). A crop container 112 may be formed of at least one of a polymer, a plastic, a fiber-based material, a metal, resin, nylon, cotton, terracotta, wood, stone, biodegradable material, or the like. A crop container may hold a plant. For example, a plant's roots may be placed in soil in the crop container 112. In another embodiment, a plant's roots may be place in water without soil.

A container link 114 may be a line member extending from a crop container 112 to a suspension extension 120. Herein, the term “line member” is intended to include rigid, semi-rigid, and flexible structures such as rods, pipes, chains, cables, ropes, lines, and the like. The line member may be formed of at least one of a polymer, a plastic, a fiber-based material, a metal, resin, nylon, cotton, or the like. One or more of the above-discussed fasteners may be attached to or integral with a line member. In an embodiment, a container link 114 may range in length from about 6 inches to about 6 feet and in diameter from about 0.005 inch to about 1 inch. In another embodiment, a container link 114 may range in length from about 6 inches to about 3 feet and in diameter from about 0.1 inch to about 0.5 inch.

As an example of the container link 114 being a line member, a container link 114 may include a solid metal rod with one or more fasteners at ends of the rod to fasten an end (e.g., lower end) of the container link 114 to the crop container 112 and another end (e.g., an upper end) of the container link 114 to the suspension extension 120. While container links 114 are shown in an embodiment as solid, links may be hollow (e.g., a hollow rod) so as to reduce weight in other embodiments. In an embodiment, at least three links 114 may be provided for a single crop container 112.

A suspension extension 120 may be a line member extending from one or more container links 114 to the upper support 130. A suspension extension 120 may extend substantially along a vertical direction and may be connected to the upper support 130 at an upper end and to a crop container 112 at a lower end (e.g., via container links 114). In an embodiment, a suspension extension 120 may range in diameter from about 0.005 inch to about 1 inch. In another embodiment, a suspension extension 120 may range in diameter from about 0.01 inch to about 0.5 inch (e.g., about ⅛^{th} of an inch).

One of ordinary skill in the art will appreciate that the length of a suspension extension 120 may vary depending upon which layer (e.g., tier, level) a crop container 112 connected to said suspension extension 120 is to be located. For example, in an at least three-tier embodiment (i.e., at least three levels in the system), at least three subgroups of suspension extensions 120 (121, 122, 123) may be provided. For example, a first subgroup of suspension extensions 121 may have a first length, a second subgroup of suspension extensions 122 may have a second length, and a third subgroup of suspension extensions 123 may have a third length. In an embodiment, the first subgroup of suspension extensions 121 may be shorter than the second subgroup of suspension extensions 122 and the third subgroup of suspension extensions 123. The second subgroup of suspension extensions 122 may be shorter than the third subgroup of suspension extensions 123. The number of layers provided may vary from embodiment to embodiment, so long as a plurality of layers is provided. For example, in an embodiment shown in FIGS. 1-4, seven tiers or levels (or layers) may be provided having seven sub-groups of suspension extensions. In another embodiment, six layers may be provided having six sub-groups of suspension extensions.

In an embodiment, the first subgroup of suspension extensions 121 may range in length from about 1 foot to about 5 feet, the second subgroup of extensions 122 may range in length from about 2 feet to about 12 feet, and the third subgroup of extensions 123 may range in length from about 3 feet to about 19 feet. In another embodiment, the first subgroup of suspension extensions 121 may range in length from about 1 foot to about 3 feet (e.g., about 2 feet), the second subgroup of extensions 122 may range in length from about 2 feet to about 6 feet (e.g., about 4 feet), and the third subgroup of extensions 123 may range in length from about 3 feet to about 10 feet (e.g., about 6 feet).

As an example of a suspension extension 120 being a line member, a suspension extension 120 may include a solid metal rod with one or more fasteners (e.g., a hook, a hole, a nut, a bolt, a crimp, etc.) at ends of the suspension extension 120 to fasten an end (e.g., a lower end) of the suspension extension 120 to the links 114 and another end (e.g., an upper end) of the suspension extension 120 to the upper support 130. For example, the upper end of the suspension extension 120 may be crimped to a support of the upper support 130. In another embodiment, the upper support 130 may include holes into which a hook of a respective suspension extension 114 may be placed.

In other embodiments, the length of a suspension extension 120 may be fixed and multiple layers may be possible by connecting a third-layer crop container 112 to a second-layer crop container 112, which may be connected to a first-layer crop container 112, which may be connected to the upper support 130. In such embodiments, suspension extensions 120 may extend from the third-layer crop container to the second-layer crop container, and so on, and suspension extensions 120 may extend from the first-layer crop container 112 to the upper support 130.

Turning back to FIG. 1, in an embodiment, a ring subassembly 115 may be placed on the crop container 112 to contain plant foliage. The ring subassembly 115 may prevent a plant's foliage from spreading beyond a predetermined amount of space while not hindering effective growth of the plant. In an embodiment, the ring subassembly 115 may include a first ring and a second ring connected by a fastener (e.g., a clamp or an integral connection) to a container link 114. In another embodiment, the ring subassembly may instead be connected by a fastener to a suspension extension 120 that may be connected to another crop container 112. For example, the ring subassembly 115 of a second-level crop container 112 may be connected to the suspension extension 120 of a third-level crop container 112. In an embodiment, the ring subassembly 115 may be slidable along the suspension extension 120.

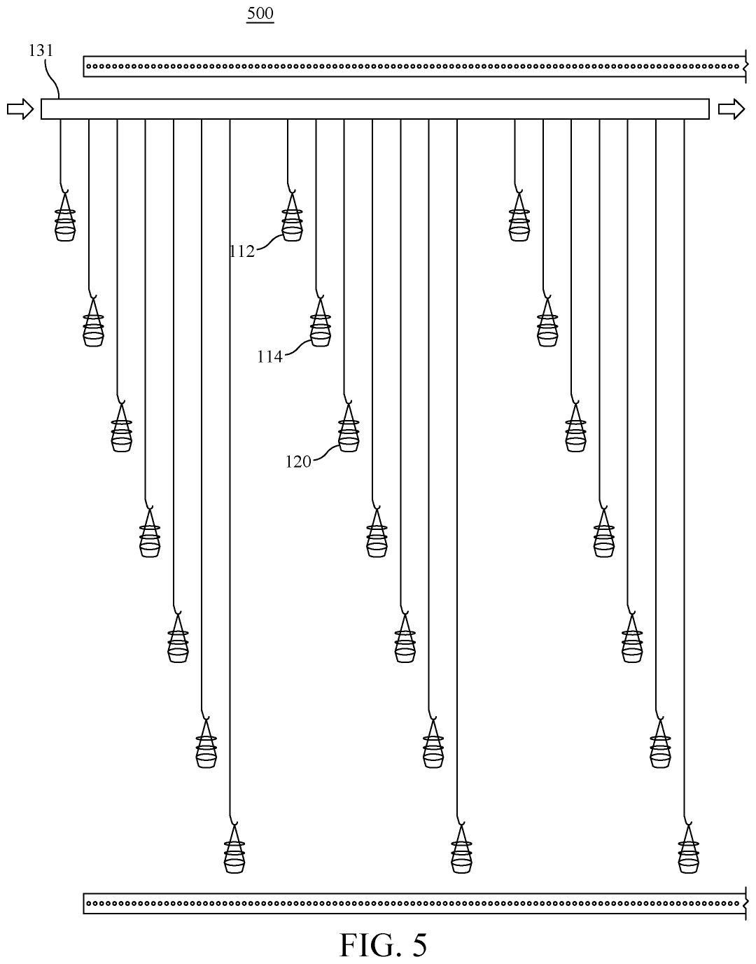

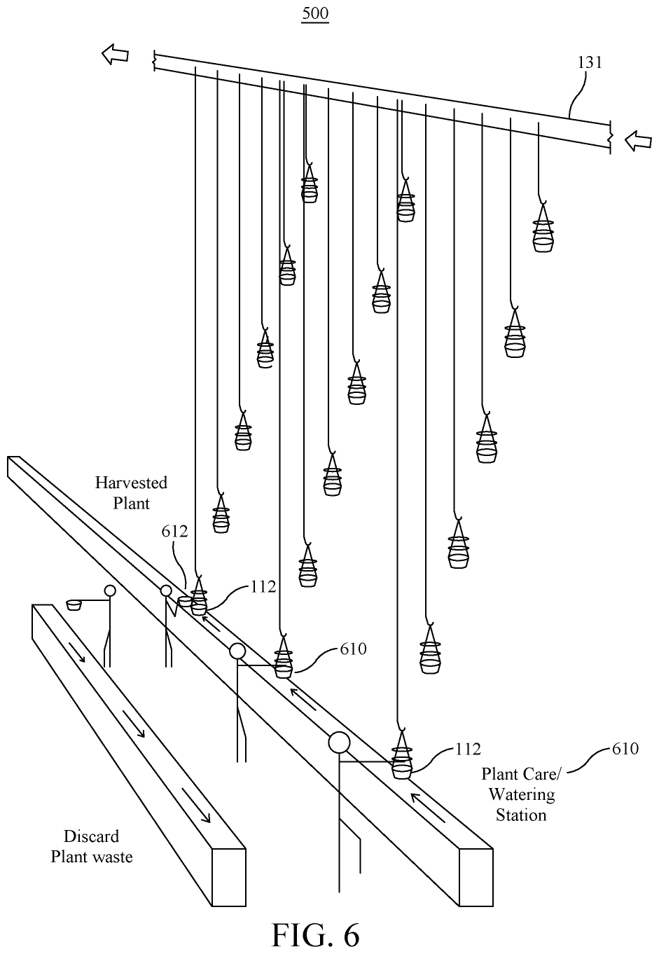

FIG. 5 is a block diagram schematically showing select components of a vertical farming system 500 according to an embodiment. FIG. 6 is a front perspective view schematically showing select components of the vertical farming system 500 of FIG. 5. Components of the vertical farming system 500 may be the same or similar to the components of the vertical farming system 100 of FIGS. 1-4. Duplicative descriptions will be omitted in the interest of clarity of description, and differences will be described.

In the vertical farming system 500, a conveyor upper support 131 may be provided, which may be different from a fixed upper support 130 shown in FIGS. 1-4. For example, the conveyor upper support 131 may include a movable track system (or any other appropriate movable conveyor system) as a support to which suspension extensions 120 may be extended and connected. The movable track system may be driven by an appropriate motor. The movable track system may be suspended from an upper surface of a greenhouse. The crop containers 112 may be moved from plant care station to plant care station (e.g., a light station, a watering station, etc.) via movement along the movable track system.

For example, as schematically represented in FIG. 6, the conveyor upper support 131 may be activated to move in a direction (as illustrated in FIG. 6, to the left). The attached crop containers 112 may be moved to plant care stations (e.g., watering/nutrition stations 610) for specified plant care (e.g., watering/nutrition). Crop containers 112 may be moved to another plant care station (e.g., harvesting station 612) for harvesting. In an embodiment, the crop containers 112 may be circulated according to an automatic cycle. In another embodiment, the crop containers may be circulated (or moved) according to manual input.

A density of the crop containers 112 in an embodiment of the vertical farming system 100 may be determined based on factors including a size of the crop containers and a diameter of the suspension extensions. For example, in the case of an upper support that is movable (e.g., a conveyor upper support 131), the crop containers may need to be spaced apart about 4 inches in the case of an about eight inch pot so as to allow room for the suspension extensions 120.

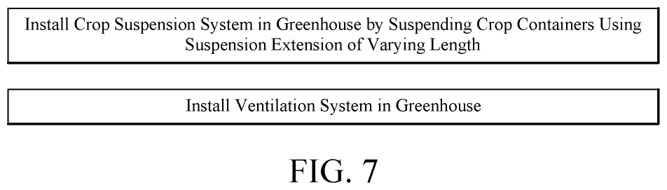

FIG. 7 is a schematic flow chart showing a method 700 of installing a vertical farming system 100, 500 according to an embodiment. The method 700 may include installing a crop suspension system 150 in a greenhouse, closed container, or other enclosure, and installing a ventilation system 150 in the greenhouse, closed container, or other enclosure. The installing of the crop suspension system 110 may include suspending crop containers 112 using suspension extensions 120 connected to the crop containers 112 and an upper support 130, 131 connected. The suspension extensions 120 may include subgroups 121, 122, 123 of different lengths relative to the upper support 130, 131.

According to embodiments presented herein, airflow in conjunction with vertical farming may be improved. Multiple stacked layers (e.g., tiers, levels) of a crop may be suspended such that airflow (e.g., vertical airflow) may not be obstructed and lighting efficiency may be improved. Improved airflow control, temperature control, and humidity control, and water and nutrient distribution efficiency may be achieved, as may disinfection, pest control, and correct Vapor Pressure Deficit (VFD) optimized air. This may lead to higher energy efficiency and greater crop yield and quality.

Embodiments have been disclosed herein, and although terms are employed, they are used and are to be interpreted in a generic and descriptive sense only and not for purpose of limitation. In some instances, as would be apparent by one of ordinary skill in the art, features and characteristics described in connection with an embodiment may be used singly or in combination with features and characteristics described in connection with other embodiments unless otherwise specifically indicated. Accordingly, it will be understood by those of ordinary skill in the art that various changes in form and details may be made without departing from the spirit and scope of the disclosure as set forth herein.

What is claimed is:

1. A vertical farming system promoting uniform crop airflow in an enclosure, the system comprising:
a crop suspension system, including:
crop containers;
suspension extensions connected to the crop containers; and
an upper support disposed at an upper side of the enclosure and connected to the suspension extensions, and
a ventilation system including:
a main upper airway disposed at the upper side of the enclosure;
upper branch airways in fluid communication with the main upper airway and disposed at the upper side of the enclosure;
a main lower airway disposed at a lower side of the enclosure; and
lower branch airways in fluid communication with the main lower airway,
wherein the suspension extensions comprise subgroups of different lengths relative to the upper support.

2. The system of claim 1, wherein the enclosure is a greenhouse.

3. The system of claim 1, further comprising:
a first subgroup of the crop containers that are connected to the user support by a first subgroup of the suspension extensions having a first length, the first subgroup of crop containers being suspended at a first distance relative to the upper support;
a second subgroup of the crop containers that are connected to the user support by a second subgroup of the suspension extensions having a second length, the second subgroup of crop containers being suspended at a second distance relative to the upper support, the second distance being greater than the first distance; and
a third subgroup of the crop containers that are connected to the user support by a third subgroup of the suspension extensions having a third length, the third subgroup of crop containers being suspended at a third distance relative to the upper support, the third distance being greater than the second distance.

4. The system of claim 1, wherein the crop suspension system includes links connecting the crop containers to the suspension extensions.

5. The system of claim 1, wherein the crop suspension system includes lights.

6. The system of claim 1, wherein the ventilation system includes a heater, an air conditioner, a blower, and an airway system, which define a reversable airflow path.

7. The system of claim 6, wherein the fan is in fluid communication with an external environment.

8. A method of installing a vertical farming system promoting uniform crop airflow in an enclosure, the method comprising:
installing a crop suspension system in the enclosure by suspending crop containers using suspension extensions that are connected to the crop containers and an upper support disposed at an upper side of the enclosure, and
installing a ventilation system in the enclosure by disposing a main upper airway at the upper side of the enclosure, disposing upper branch airways in fluid communication with the main upper airway at the upper side of the enclosure, disposing a main lower airway at a lower side of the enclosure, and disposing lower branch airways in fluid communication with the main lower airway at the lower side of the enclosure,
wherein the suspension extensions comprise subgroups of different lengths relative to the upper support.

9. The method of claim 8, wherein the enclosure is a greenhouse.

10. The method of claim 8, wherein the installing of the crop suspension system includes:
suspending a first subgroup of the crop containers connected to the user support by a first subgroup of the suspension extensions having a first length at a first distance relative to the upper support;
suspending a second subgroup of the crop containers connected to the user support by a second subgroup of the suspension extensions having a second length at a second distance relative to the upper support, the second distance being greater than the first distance; and
suspending a third subgroup of the crop containers connected to the user support by a third subgroup of the suspension extensions having a third length at a third distance relative to the upper support, the third distance being greater than the second distance.

11. The method of claim 8, wherein the crop suspension system includes links connecting the crop containers to the suspension extensions.

12. The method of claim 8, wherein the crop suspension system includes lights.

13. The method of claim 8, wherein the ventilation system includes a heater, an air conditioner, a blower, and an airway system, which define a reversable airflow path.

14. The method of claim 13, wherein the fan is in fluid communication with an external environment.
